(19) United States
(12) Patent Application Publication
(10) Pub. No.: US 2012/0226647 A1
(43) Pub. Date: Sep. 6, 2012

(54) FLIGHT ITINERARY DELAY ESTIMATION

(75) Inventors: Geoffrey C. Murray, Lake Forest, IL (US); Roger F. Teal, Wilmette, IL (US); William Thacker, Chenoa, IL (US); Dennis Taylor, Independence, MO (US); Ivan Bekkers, Milton, GA (US)

(73) Assignee: BUSINESS TRAVEL ALTERNATIVES, LLC, Mitlon, GA (US)

(21) Appl. No.: 13/411,144

(22) Filed: Mar. 2, 2012

Related U.S. Application Data
(60) Provisional application No. 61/448,922, filed on Mar. 3, 2011.

(51) Int. Cl. G06N 5/02

(52) U.S. Cl. 706/47; 706/46

(57) ABSTRACT

A system includes a processor and a memory communicatively coupled to the processor. The memory stores instructions causing the processor, after execution of the instructions by the processor, to: receive a first flight itinerary of a user; receive condition data and weather forecast data for airports, estimate a likelihood for a delay of the first flight itinerary based on the condition data and the weather forecast data for airports associated with the first flight itinerary, identify a second flight itinerary as an alternative for the first flight itinerary, estimate a likelihood for a delay of the second flight itinerary based on the condition data and the weather forecast data for airports associated with the second flight itinerary, and notify the user of the estimated likelihood for a delay for the first flight itinerary, the second flight itinerary, and the estimated likelihood for a delay for the second flight itinerary.

### CROSS-REFERENCE TO RELATED APPLICATIONS

This Utility Patent Application claims priority to Provisional Patent Application No. 61/448,922, filed Mar. 3, 2011, which is incorporated herein by reference.

### BACKGROUND

Flight delays represent one of the airline industry's major challenges and are associated with frequent traveler complaints and Department of Transportation and congressional inquiries. These delays have a significant impact on the airlines in terms of lost revenue, increased costs, and unproductive or lost time for travelers. Airlines have made recent advances by more proactively managing and communicating delays, but that information still largely remains reactive, provided in a narrow time frame, and does not anticipate weather events and likely resulting delays. Weather forecast accuracy increases as the day of the forecast approaches, and weather impacts flight and airport operations.

Weather causes close to half of all airline flight delays as reported by the US Department of Transportation, but those figures do not accurately capture passenger delays. As a result of the airlines utilization of connecting flights over large airports, even a short delay can result in a missed connection and a significantly delayed itinerary. In fact, research has shown that itinerary delays are twice as high as flight delays.

Current airlines and third party services that provide flight delay information rely on information from the Federal Aviation Administration (FAA) or airlines for their flight status information and limit their services to within a few hours of planned departure time.

### SUMMARY

One embodiment provides a system including a processor and a memory communicatively coupled to the processor. The memory stores instructions causing the processor, after execution of the instructions by the processor, to: receive a first flight itinerary of a user, receive condition data and weather forecast data for airports, estimate a likelihood for a delay of the first flight itinerary based on the condition data and the weather forecast data for airports associated with the first flight itinerary, identify a second flight itinerary as an alternative for the first flight itinerary, estimate a likelihood for a delay of the second flight itinerary based on the condition data and the weather forecast data for airports associated with the second flight itinerary, and notify the user of the estimated likelihood for a delay for the first flight itinerary, the second flight itinerary, and the estimated likelihood for a delay for the second flight itinerary.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a block diagram illustrating one embodiment of a flight itinerary delay prediction processing system.

FIG. 2 is a block diagram illustrating one embodiment of a flight itinerary delay prediction system.

FIG. 3 is a flow diagram illustrating one embodiment of a process for predicting delays for flight itineraries.

FIG. 4 is a flow diagram illustrating one embodiment of a process for collecting airport and weather forecast data to determine the likelihood of an airport delay.

FIG. 5 is a flow diagram illustrating one embodiment of a process for determining whether a planned flight itinerary is delayed and whether there are alternative flight itineraries.

FIG. 6 is a flow diagram illustrating one embodiment of a process for determining alternative flight itineraries.

FIG. 7 is a flow diagram illustrating one embodiment of a process for notifying a user.

FIG. 8 is a block diagram illustrating one embodiment of a user profile storage and management system.

FIG. 9 is a map of the United States with a depicted weather front and a plotted itinerary to illustrate the impact of weather at a connecting airport on a flight itinerary.

### DETAILED DESCRIPTION

In the following Detailed Description, reference is made to the accompanying drawings, which form a part hereof, and in which is shown by way of illustration specific embodiments in which the disclosure may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

It is to be understood that the features of the various exemplary embodiments described herein may be combined with each other, unless specifically noted otherwise.

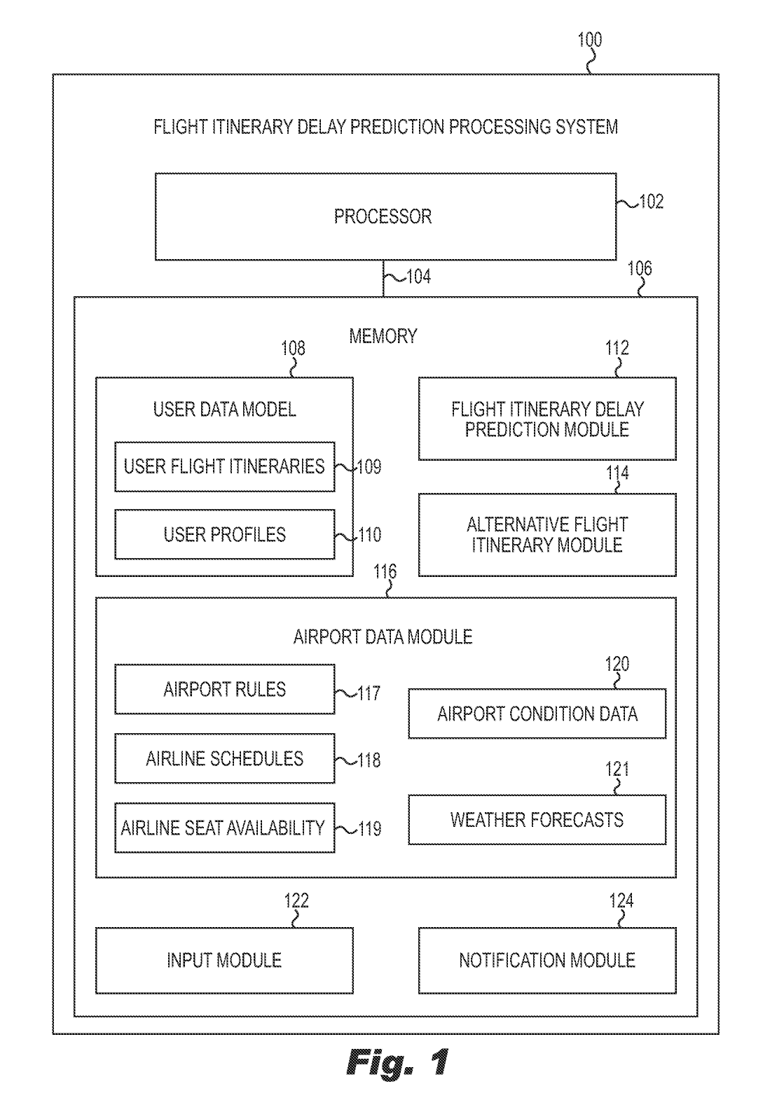

FIG. 1 is a block diagram illustrating one embodiment of a flight itinerary delay prediction processing system 100. Flight itinerary delay prediction processing system 100 includes a processor 102 and a memory 106. Processor 102 is communicatively coupled to memory 106 via communication link 104. In one embodiment, memory 106 stores instructions executed by processor 102 for operating flight itinerary delay processing system 100. Memory 106 includes any suitable combination of volatile and/or non-volatile memory, such as combinations of Random Access Memory (RAM), Read-Only Memory (ROM), flash memory, and/or other suitable memory. Memory 106 stores instructions executed by processor 102 including instructions for a user data module 108, a flight itinerary delay prediction module 112, an alternative flight itinerary module 114, an airport data module 116, an input module 122, and a notification module 124.

User data module 108 receives and manages user data including user flight itineraries 109 and user profiles 110. In one embodiment, user flight itineraries 109 and user profiles 110 are input to flight itinerary delay prediction processing system 100 through input module 122. Airport data module 116 receives and manages airport, airline, and weather data including airport rules 117, airline schedules 118, airline seat availability 119, airport condition data 120, and weather forecasts 121. In one embodiment, airport rules 117, airline schedules 118, airline seat availability 119, airport condition data 120, and weather forecasts 121 are input to flight itinerary delay prediction processing system 100 through input module 122.

Flight itinerary delay prediction module 112 evaluates the user flight itineraries 109 based on airport rules 117, airport condition data 120, and weather forecasts 121 to determine the potential for delays for the user flight itineraries. Alternative flight itinerary module 114 determines if there are any available alternative flight itineraries for user flight itineraries based on user profiles 110, airline schedules 118, and airline seat availability 119. Notification module 124 notifies users of potential delays to their flight itineraries and alternative flight itineraries if available.

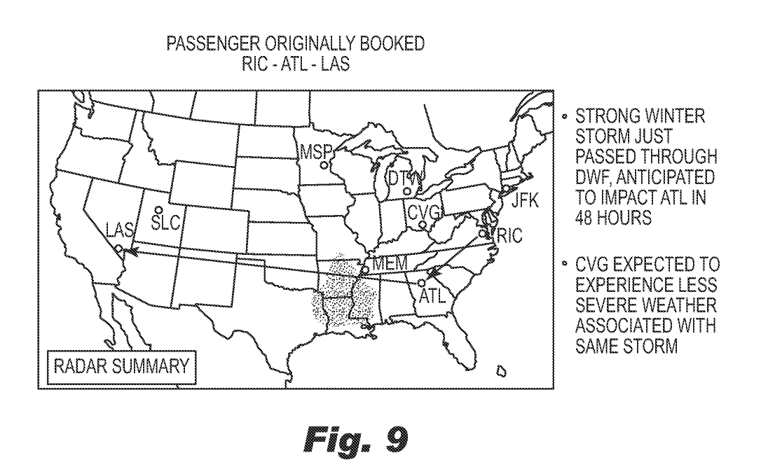

FIG. 9 is a map of the United States with a depicted weather front and a plotted itinerary to illustrate the impact of weather at a connecting airport on a flight itinerary. FIG. 9 illustrates the problem flight itinerary delay prediction processing system 100 addresses. The map reflects a planned itinerary commencing in Richmond, Va. (RIC) and concluding in Las Vegas, Nev. (LAS), via Atlanta, Ga. (ATL). The weather chart indicates that the Dallas-Ft. Worth, Tex. airport (DFW) has experienced weather impacting flight operations with this system and it is forecast to arrive in ATL in the next 45 to 50 hours. The itinerary is planned to depart ATL in two days, which will coincide with the weather arriving in ATL. Given the weather forecast and its impact on airport and aircraft operations, flights in or out of ATL are likely to be delayed or canceled. Thus, the traveler's entire itinerary is affected by the connection in ATL.

Flight itinerary delay prediction processing system 100 provides users with a system and method to predict flight itinerary delays or cancellations commencing several days (e.g., one week, six days, five days, four days, three days, two days, one day, or other suitable time period) ahead of the planned itinerary departure time. Flight itinerary delay prediction processing system 100 communicates with users through a communications infrastructure that includes but is not limited to internet document protocols, file transfer protocols, simple object access, remote procedure calls, internet mail protocols, internet news feed protocols, wireless, phone, and cell phone short message protocols. Service delivery can be provided through a web page, mobile application, client application, email, voice response, any form of text message such as Multimedia Messaging Service (MMS), Short Message Service (SMS), or as requested directly by users.

Further, flight itinerary delay prediction processing system 100 obtains weather information from a variety of sources, parses, and normalizes the information to forecast airport performance in a particular geography, and assigns an expected operational status in prescribed time intervals several days in advance, concluding at scheduled departure time.

Further, flight itinerary delay prediction processing system 100 evaluates planned travel itineraries from travelers, groups of travelers, or any entity interested in travel itinerary data between an arrival and destination airport and the impact of the predicted delays at any of the airports along the planned itinerary, yielding a predicted status of the entire itinerary.

Further, flight itinerary delay prediction processing system 100 provides the user with alternatives to the planned itinerary that have also been evaluated against the delay prediction program and subsequently provide a relative score for those alternatives. Alternatives are presented after evaluating alternative itineraries for predicted delay status and delivered to the user.

Further, flight itinerary delay prediction processing system 100 notifies users of the predicted delay and provides acceptable alternatives that were similarly evaluated for delays. Users can be notified via a variety of methods including electronic, human, and automated telephonic delivery.

Further, flight itinerary delay prediction processing system 100 can use industry or other sources to identify alternative itineraries utilizing data from suppliers such as OAG (Official Airlines Guide), Innovata LLC, or travel intermediaries such as the Global Distribution Systems, Google/ITA Software and others.

Further, flight itinerary delay prediction processing system 100 allows users to register their preferences for acceptable itinerary alternatives to allow users to register their preferences for tracking and notification preferences, contact details, and other data.

Further, flight itinerary delay prediction processing system 100 allows airlines to manage preferences on behalf of different travel segments such as frequent flyer program status, ticket value, and other variables.

Further, flight itinerary delay prediction processing system 100 incorporates airport operating characteristics into the delay forecasts, identifying how similar weather can differently impact similar airports. These operating characteristics can include runway configuration, wind direction, ability to manage ice and snow, impact of cold weather conditions, and other factors that influence arrival and departure rates at the airport level and also at the individual airline's operations.

Further, flight itinerary delay prediction processing system 100 incorporates aircraft operating characteristics and constraints that impact aircraft flight operations such as de-icing capabilities, runway closures, and other airport constraints.

Further, flight itinerary delay prediction processing system 100 enables users to receive reports and records that are archived on a periodic basis. Records and reports are archived daily reflecting the predicted status of airports and itineraries as well as the actual status of the itineraries and airports as reported by the US Department of Transportation (DOT), the airlines, and the Federal Aviation Administration (FAA).

Flight itinerary delay prediction processing system 100 complements current information sources that communicates flight delay information including airline-generated flight status messages, information providers acquiring data based on radar displays from such organizations as the Federal Aviation Authority or information providers that review filed flight plans, and/or rely on data provided by Air Traffic Control systems. All such providers have a very limited time horizon—often less than 24 hours—before the flight operation.

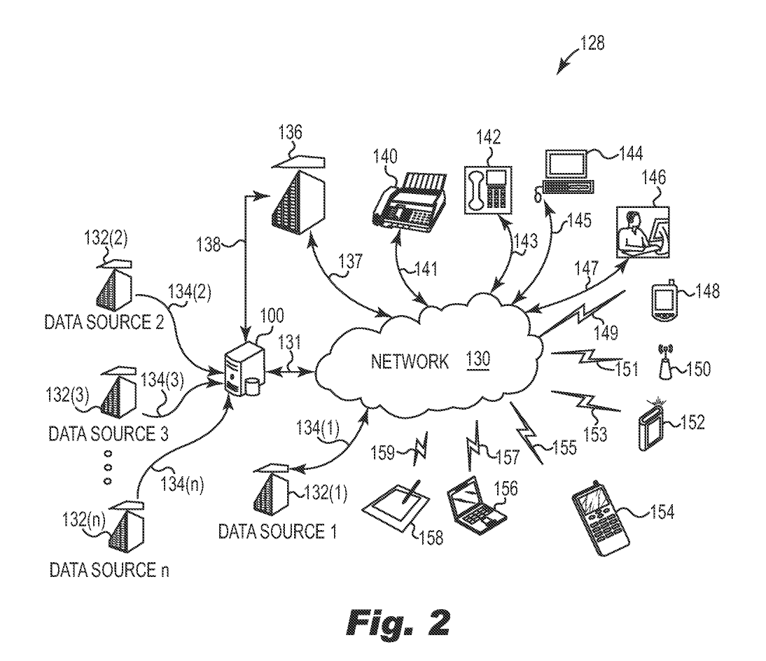

FIG. 2 is a block diagram illustrating one embodiment of a flight itinerary delay prediction system 128. Flight itinerary delay prediction system 128 includes flight itinerary delay prediction processing system 100 previously described and illustrated with reference to FIG. 1. Flight itinerary delay prediction system 128 facilitates collection of data from a plurality of suppliers, 132(1)-132(n), including in one embodiment human interfaces, through communication links 134(1)-134(n), respectively, where “n” is any suitable number of suppliers. Weather forecasts and other data streams received from the suppliers (e.g., through input module 122 (FIG. 1)) are normalized by flight itinerary delay prediction processing system 100, which processes the data to predict delays and to provide alternative flight itineraries. The results are subsequently distributed to users (e.g., through notification module 124 (FIG. 1)) via the network 130.

Each of the plurality of data suppliers 132(1)-132(n) is connected to the flight itinerary delay prediction processing system 100 via a network communication link. Similarly, each of the plurality of users is connected to flight itinerary delay prediction processing system 100 via a network communication link.

Network communication links to network 130, as used herein, are each defined to include an internet communication link, an intranet communication link, or a similar high-speed communication link. In one embodiment, network communication links 137, 138, and 134(1)-134(n) include at least one Virtual Private Network (VPN), or other public or private network communication link. In another embodiment, network communication links 137, 138, and 134(1)-134(n) include a wireless communication link. In another embodiment, each of the plurality of suppliers 132(1)-132(n) and/or each of the plurality of users are connected via different embodiments of network communication link 131.

Each of the users is connected to flight itinerary delay prediction processing system 100 via communication protocols and provisioned on user devices. User devices include a multitude of options such as a fax machine 140 communicatively coupled to network 130 via communication link 141, a telephone 142 communicatively coupled to network 130 via communication link 143, a personal digital assistant 148 communicatively coupled to network 130 via wireless communication link 149, a wireless phone 154 communicatively coupled to network 130 via wireless communication link 155, a pager 152 communicatively coupled to network 130 via wireless communication link 153, a wireless computer including but not limited to a laptop 156 communicatively coupled to network 130 via wireless communication link 157, a netbook, a tablet device 158 communicatively coupled to network 130 via wireless communication link 159, a desktop computer 144 communicatively coupled to network 130 via communication link 145, a wireless station 150 communicatively coupled to network 130 via wireless communication link 151, a voice response unit 146 communicatively coupled to network 130 via communication link 147, a user server, and others. Communication methods to such devices will depend on the device and user and are captured in user profiles 110 (FIG. 1).

The delivery platforms include, but are not limited to, a web page, a data stream such as Extensible Markup Language (XML), a data file, a client application, an e-mail message, a text message, an instant message, a broadcast message, an audio message, a Short Message Service (SMS) text message, a HyperText Markup Language (HTML) message, or any other suitable message type capable of facilitating communication of information.

In one embodiment, servers 136 are used to implement at least a portion of flight itinerary delay prediction processing system 100. Communication to servers 136 via communication links 137 and/or 138 utilizes standard industry protocols including Transmission Control Protocol/Internet Protocol (TCP/IP), Hypertext Transfer Protocol (HTTP), XML, Simple Object Access Protocol (SOAP), File Transfer Protocol (FTP), Real-time Transport Protocol (RTP), and the like. Server communication includes various security measures including XML data types encoded and decoded for interoperability, Request and Response messages secured through transport-layer encryption using Secure Sockets Layer (SSL) protocol or through a symmetric encryption mechanism, and servers configured with an SSL Digital Certificate from a trusted certificate authority.

Network communication to local area networks (LAN), wide area networks (WAN), personal networks, or other type of networks as well as other wireless devices 148, 150, 152, 154, 156, and 158 may include internet communication links, such as an Internet communication link, an intranet communication link, or a similar high-speed communication link.

Components of the embodiments can be implemented in hardware via a microprocessor, programmable logic, state machine, in firmware, or in software within a given device. In one embodiment, at least a portion of the software programming is web-based and written in HTML and JAVA programming languages, including links to user interfaces for data collection, such as a Windows-based operating system. Each of the main components may communicate via a network using a communication bus protocol. For example, embodiments may use a TCP/IP protocol suite for data transport. Other programming languages and communication bus protocols suitable for use with the embodiments will become apparent to those skilled in the art after reading the present application. Components of the embodiments may also reside in software on one or more computer-readable mediums. The term “computer-readable medium” as used herein is defined to include any suitable kind of storage memory, volatile or non-volatile, such as floppy disks, hard disks, CD-ROMs, flash memory, read-only memory (ROM), and random access memory (RAM).

Any of the databases used to implement flight itinerary delay prediction processing system 100 may include any combination of software and hardware. The databases may include an application known as a (Relational) Database Management System ((R)DBMS). The databases may be housed in any location, are designed to run single or multiple applications, and can operate continuously for extended periods of time. The flight itinerary delay prediction processing system 100 can contain several databases that can be of separate structure as well as different software vendors.

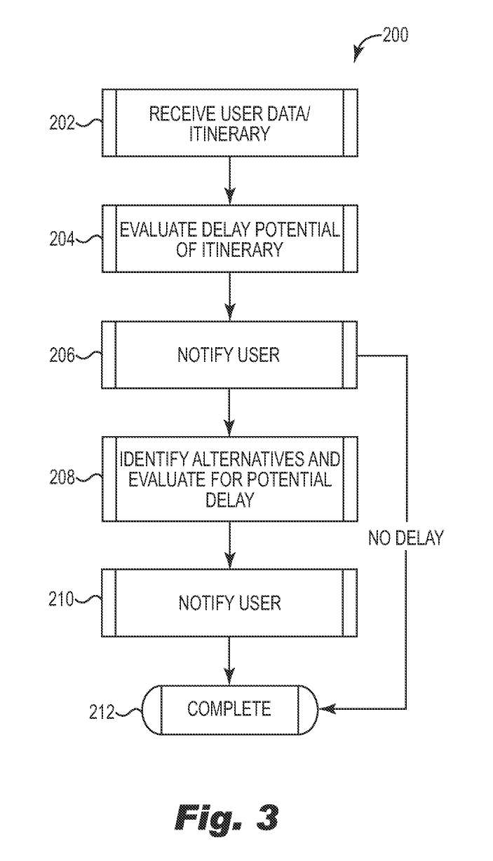

FIG. 3 is a flow diagram illustrating one embodiment of a process 200 for predicting delays for flight itineraries. In one embodiment, process 200 is implemented by flight itinerary delay prediction processing system 100 previously described and illustrated with reference to FIG. 1. Process 200 begins by collecting information from a variety of sources at 202. In one embodiment, the information is received by input module 122 (FIG. 1) and includes user flight itineraries and user profile data. At 204, and user registered itineraries are evaluated to predict and evaluate possible delays. In one embodiment, the itineraries are evaluated by flight itinerary delay prediction module 112 (FIG. 1). At 206, the users are notified of any predicted delay situation. In one embodiment, the users are notified via notification module 124 (FIG. 1). If there is no predicted delay situation for a user, the process is complete as indicated at 212. If there is a predicted delay situation, then at 208, alternative itineraries are identified and evaluated for potential delays. In one embodiment, the alternative itineraries are identified by alternative flight itinerary module 114 (FIG. 1) and evaluated for potential delays by flight itinerary delay prediction module 112 (FIG. 1). At 210, the users are notified of any alternative itineraries and potential delays for the alternative itineraries based upon the agreed-upon protocols for each user. In one embodiment, the users are notified via notification module 124 (FIG. 1).

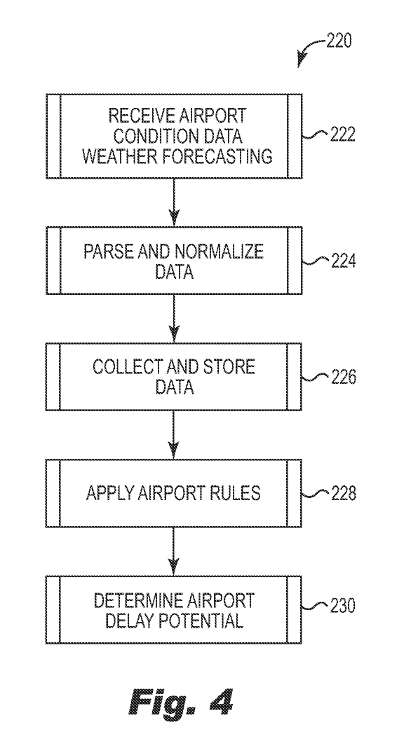

FIG. 4 is a flow diagram illustrating one embodiment of a process 220 for collecting airport and weather forecast data to determine the likelihood of an airport delay. In one embodiment, process 220 is implemented by airport data module 116 of flight itinerary delay prediction processing system 100 previously described and illustrated with reference to FIG. 1. At 222, current airport condition and forecast weather data is received from several sources. In one embodiment, the data is received by input module 122 (FIG. 1). The data is received from sources including, but not limited to, the Federal Aviation Administration (FAA), National Weather Service (NWS), National Oceanic and Atmospheric Administration (NOAA), private and public weather services and forecasting entities and meteorologists. Several forecasting models are used by the system such as, but not limited to: Global Forecasting System (GFS), North American Mesoscale Model (NAM), and Rapid Update Cycle Model (RUC). The airport and forecast data is received in various electronic formats across different media and may be entered into the system manually by a human weather forecaster. The airport and weather forecast data includes, but is not limited to, wind direction and velocity, prevailing visibility, precipitation type and intensity, temperature, dew point, cloud coverage and ceiling height, frontal location, convective activity, icing level, airport and facility condition, and other factors.

In one embodiment, the airport condition data also includes airport demand based on airline schedules (e.g., airline schedules 118 (FIG. 1)), which indicate the number the scheduled flights arriving and departing from each airport. The airport demand has an effect on the determination of the likelihood of an airport delay. For example, if airport demand is relatively low, poor weather conditions may not increase the likelihood of an airport delay. If, however, airport demand is relatively high, poor weather conditions may increase the likelihood of an airport delay. The effect of airport demand in relation to weather conditions may also vary based on the airport's location and the airport's ability to operate during poor weather conditions. For example, the Chicago O'Hare airport may be able to handle a specified airport demand in certain weather conditions (e.g., snow) without delays while the Dallas-Ft. Worth airport would likely have delays for a similar airport demand and weather conditions.

At 224, the received data is parsed and normalized into a common language and format that can be used by flight itinerary delay prediction processing system 100. At 226, the parsed data is collected and the meteorological data is stored on local and/or network database servers. In one embodiment, the parsed and normalized airport and weather forecast data is stored as airport condition data 120 (FIG. 1) and weather forecasts 121 (FIG. 1), respectively. The airport and weather forecast data is generally commenced, but not necessarily limited to, 120 hours in the future, and updated at regular intervals until a set time prior to scheduled departure at which time real-time notifications can take over. The data may be retained for an indefinite period. The data is sorted, collected, and processed so that the data required for applying the airport rules 117 (FIG. 1) at 228 is stored and indexed.

The airport rules 117 (FIG. 1) is a set of rules designed for every individual airport including the generally used air traffic arrival/departure route gateway fixes or “posts” used by the National Air Transportation System (NATS) at large airports. An example of an arrival post for Chicago O'Hare (ORD) is the Pullman VOR. Pullman is a navigational fix located northeast of ORD. Nearly all air traffic to ORD from the northeast must overfly Pullman. Thunderstorms or other severe weather near Pullman will disrupt arrival traffic into ORD, increasing the potential for a delay. Airport rules 117 are a set of heuristically and/or mathematically derived weather parameters and/or airport or airport post conditions that when exceeded it is reasonable to expect an airport delay. Given that weather and other parameters affect individual airports differently, each airport is assigned a specific set of rules applicable only to that airport. An example of an airport rule may be described as follows: with winds from 020° to 120° in excess of 20 knots and/or a visibility of less than one nautical mile there is a high likelihood of a delay, or that given an expected number of operations (i.e., based on airport demand described above) at an airport within a specific timeframe and weather below a specific minimum, there is a chance for a delay. The airport rules are applied to the collected and stored data (e.g., airport condition data 120 and weather forecasts 121) to determine at 230 a dynamically updated list of airports that captures potential delays over a specified period of time.

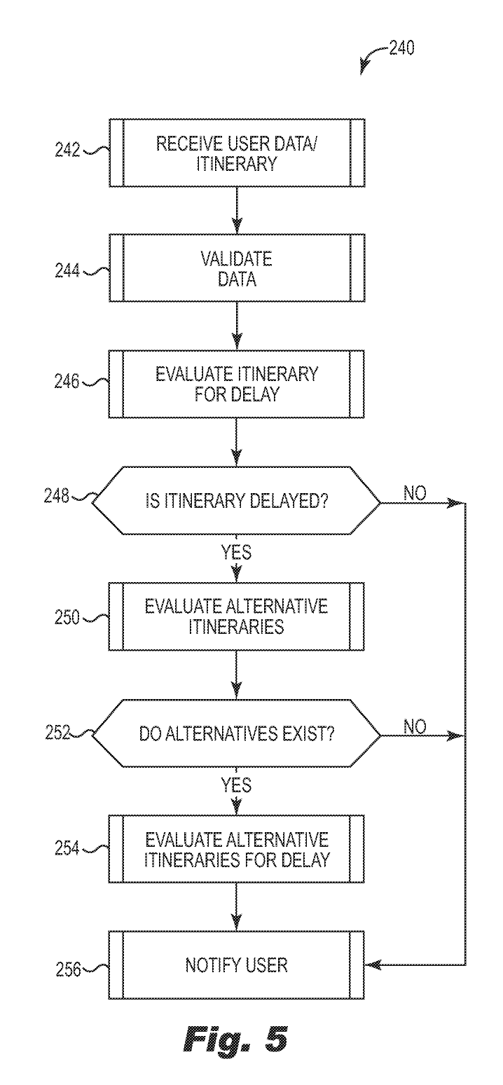

FIG. 5 is a flow diagram illustrating one embodiment of a process 240 for determining whether a planned flight itinerary is delayed and whether there are alternative flight itineraries. In one embodiment, process 240 is implemented by flight itinerary delay prediction processing system 100 previously described and illustrated with reference to FIG. 1. Process 240 receives flight itinerary data, parses that data, estimates the likelihood for an airport delay, identifies any acceptable alternative routings, evaluates those routings for delays, and notifies the user.

At 242, user data is received including flight itineraries. In one embodiment, the user data is received by input module 122 (FIG. 1) and the flight itineraries are stored as user flight itineraries 109 and the user data is stored in user profiles 110. At 244, the data is verified as accurate and relevant. At 246, the airports associated with the validated itineraries are taken and run through the list of airports that have potential delays as determined at 230 in FIG. 4 to evaluate the likelihood for a delay. In one embodiment, the likelihood for a delay is determined by flight itinerary delay prediction module 112 (FIG. 1). If a delay is not likely as determined at 248, the user will be notified at 256 and the process ends. In one embodiment, the user is notified via notification module 124 (FIG. 1).

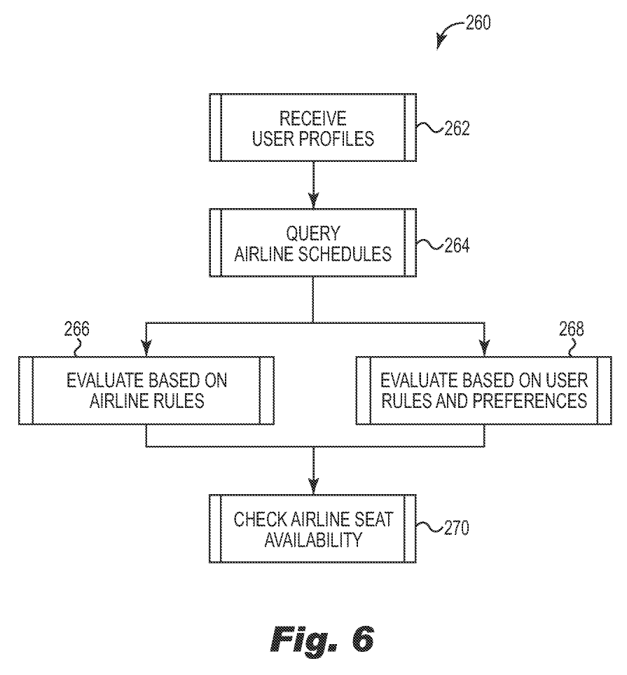

If an airport delay is likely, as determined at 248 for an itinerary, at 250 an inquiry is made to process 260 (FIG. 6) to search for acceptable alternatives. In one embodiment, alternative itineraries are determined by alternative flight itinerary module 114 (FIG. 1). If no acceptable alternatives exist as determined at 252, the user will be notified at 256. In one embodiment, the user is notified via notification module 124 (FIG. 1). If acceptable alternative routings and/or airline flights are identified that satisfy user requirements, as determined at 252, then those alternative routings and/or airline flights are evaluated for potential delays at 254. In one embodiment, the flights are evaluated for potential delays by flight itinerary delay prediction module 112 (FIG. 1). At 256, the user is notified of the viable routings and airports and the likelihood for an airport delay. In one embodiment, the user is notified via notification module 124 (FIG. 1).

In one embodiment, the original and/or alternative flight itineraries and airports are continually monitored and updated at regular and prescribed intervals. Should any forecast airport or weather data change that would affect the likelihood of a delay the user will be notified at 256.

FIG. 6 is a flow diagram illustrating one embodiment of a process 260 for determining alternative flight itineraries. In one embodiment, alternative flight itinerary module 114 of flight itinerary delay prediction processing system 100 previously described and illustrated with reference to FIG. 1 implements process 260. In one embodiment, alternative flight itinerary module 114 is able to identify and verify if acceptable itinerary alternatives are available when the original submitted itinerary is evaluated as delayed at 248 (FIG. 5). At 262, the user profile (e.g., from user profiles 110 (FIG. 1)) is received. At 264, the airline schedules (e.g., airline schedules 118 (FIG. 1)) are queried to obtain any acceptable alternative itineraries. These acceptable alternative itineraries are subsequently evaluated based on user (e.g., from user profiles 110 (FIG. 1)), or airline, rules and preferences at 266 and 268.

At 264 all possible itinerary alternatives are identified by querying schedules databases as provided by industry sources such as Innovata LLC or the Official Airlines Guide/OAG Aviation. This process can also incorporate airline seat availability with airline schedules such as the Global Distribution Systems and other travel intermediaries distributing data to the travel community, including but not limited to ITA Software, Farelogix. Data is obtained, normalized, indexed, and stored for retrieval purposes.

At 268, preferences from the user profiles are used with the stored preferences for arrival/departure time, preferred airline, time window allowable for alternatives offered (e.g. hours before original departure time or hours after original expected arrival time), duration of total travel, and number of connecting cities. At 264 the customer type is recognized by querying user profiles, receiving alternative itinerary information, and sorting and filtering those preferences according to the parameters to establish the priority order of the alternative alternatives.

Group profiles such as airlines or travel agencies are enabled with dedicated filters at 266 to accommodate methods that airlines and travel agents prefer to operate when evaluating alternative itineraries for their travelers. For example, airlines and travel agents can therefore extend differentiated services to travelers' segments, which may include elite status travelers who may receive the services before lower-status travelers. At 266 preferences from the user profiles are used with the stored preferences for arrival/departure time, which airline or code share partner is preferred, non-code share airlines itineraries, what time window is allowable for acceptable alternatives to be offered (e.g. hours before original departure time or hours after original expected arrival time), duration of total travel, number of connecting cities, identifying airline preferred travelers with preferred access to seat availability, fee waivers according to airline preferred status, and other parameters. At 264 the customer type is recognized by querying user profiles, receiving alternative itinerary information, and sorting and filtering those preferences according to the parameters to establish the priority order of the alternative alternatives.

At 270, the acceptable alternatives are evaluated for seat availability (e.g., from airline seat availability 119 (FIG. 1)) and those alternatives where seat inventory does not exist can be eliminated. Seat availability can be obtained via standard internet communications methods with the airlines and/or industry providers that offer seat availability services such as the Global Distribution Systems and other travel intermediaries such as ITA Software, Farelogix and others. In one embodiment, only acceptable and available itinerary alternatives are presented to the user.

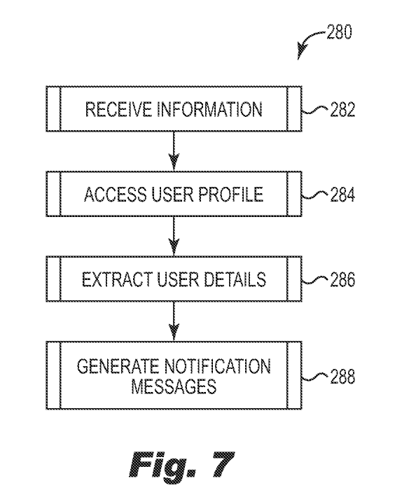

FIG. 7 is a flow diagram illustrating one embodiment of a process 280 for notifying a user. In one embodiment, notification module 124 of flight itinerary delay prediction processing system 100 previously described and illustrated with reference to FIG. 1 implements process 280. At 282, the potential for delay information from either 246 and/or 254 (FIG. 5) is received for notifying user(s). At 284, the user profiles 110 (FIG. 1) are accessed and the contact details of the user(s) to be notified are extracted at 286. At 286, any of the plurality of users that have requested delay prediction information for the registered itineraries are capable of being identified by utilizing the information in the customer profile database. At 288, notification messages are generated and sent to the corresponding plurality of users. In one embodiment, the user and message information is submitted for delivery through the network 130 (FIG. 2) for user notification on the various delivery platforms.

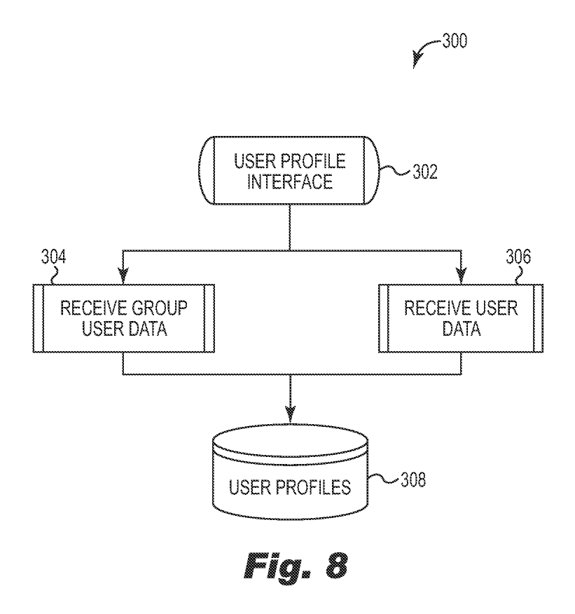

FIG. 8 is a block diagram illustrating one embodiment of a user profile storage and management system 300. In one embodiment, user profile storage and management system 300 is part of user data module 108 previously described and illustrated with reference to FIG. 1. The data collection system interacts with the plurality of suppliers as well as the user profiles 308. Itineraries submitted for evaluation and monitoring are verified for customer standing as well as for the validity of the submitted itineraries. Those itineraries are then submitted for evaluation. In one embodiment, authentication and validation are also capable of verifying that each of the plurality of users identified is authentic, active, and in good standing. The system includes a file generator further capable of generating a file for each of the requesting users in the format specified in the portion of customer profile database corresponding to the particular customer. The generated files are sent to the corresponding plurality of users.

In one embodiment, the system includes customer profile manager interface 302. The user profile database 308 is capable of providing an interface for each of the plurality of users to interact with the customer profile database to verify, add, or change entries. In one embodiment, the customer profile can be managed, edited, added, and deleted via a web interface 302 controlled by either an individual user via 306 or an entity representing a plurality of users via 304. Access to the user interface can be provided over secure standard TCP/IP web interface. Administration levels are integrated to ensure users can only access their profiles, administrators can manage the profiles of their entity, and company administrators can access all profiles.

In one embodiment, customer profile database 308 includes a security system, which allows only authorized users to access certain entries within a customer profile. In other embodiments, some entries within a customer profile are accessed only by authorized personnel.

In one embodiment, user information is verified as an airline, travel agency or other entity. Contract and user parameters are validated before being stored in the profiles database 308. In another embodiment, user information is verified as an end user. Contact and user parameters are validated before being stored in the profiles database 308.

The system includes several interfaces on various networks 130 (FIG. 2) to obtain data from various sources to be validated parsed, normalized, and stored on databases of flight itinerary delay prediction processing system 100 (FIG. 1). The different data providers can communicate with the system via a multitude of communications media.

User provisioning can be completed on various different media, including in person or voice response 146 (FIG. 2) and various electronic options. Electronic options include telephony, wireless telephony, wireless personal digital assistants, wireless tablets, wireless computers, and Ethernet and stationary computers.

Delivery methods include standard industry protocols such as TCP/IP, HTTP, XML/SOAP, FTP, RTP, and the like. Server communication can include various security features including XML data types encoded and decoded for interoperability.

Communication protocols are secured through Request and Response messages secured through transport-layer encryption using Secure Sockets Layer (SSL) protocol or through a symmetric encryption mechanism, or servers configured with an SSL Digital Certificate from a trusted certificate authority.

Embodiment provide a system and method that predicts and communicates flight itinerary information that may be delayed due to weather, commencing several days in advance of the planned departure time. More particularly, embodiments relate to a method, a computer program product, and an apparatus that predicts flight itinerary delays for users, searches for acceptable alternatives that may be less affected by weather delays, and communicates these to users.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A method comprising:
receiving, via a processing system, airport condition data and forecast weather data;
receiving, via the processing system, airport rules including weather parameters that when exceeded indicate a potential airport delay; and
applying, via the processing system, the airport rules to the airport condition data and the forecast weather data to determine potential airport delays.

2. The method of claim 1, further comprising:
parsing and normalizing, via the processing system, the received airport condition data and the forecast weather data; and
collecting and storing, via the processing system, the parsed and normalized airport condition data and the forecast weather data prior to applying the airport rules.

3. The method of claim 1, further comprising:
receiving, via the processing system, updated airport condition data and forecast weather data at regular intervals; and
applying, via the processing system, the airport rules to the updated airport condition data and the updated forecast weather data to determine potential airport delays at regular intervals.

4. The method of claim 1, comprising applying the airport rules to the airport condition data and the forecast weather data to determine potential airport delays at least 120 hours in the future.

5. The method of claim 1, wherein the airport rules comprise a set of heuristically and mathematically derived weather parameters and airport conditions that when exceeded indicate a potential airport delay.

6. The method of claim 1, wherein the airport condition data comprises at least one of airport demand, wind direction and velocity, prevailing visibility, precipitation type and intensity, temperature, dew point, cloud coverage and ceiling height, frontal location, convective activity, icing level, and airport and facility conditions.

7. The method of claim 1, wherein the forecast weather data is received from at least one of the Federal Aviation Administration (FAA), National Weather Service (NWS), National Oceanic and Atmospheric Administration (NOAA), private and public weather services, and forecasting entities and meteorologists.

8. The method of claim 1, wherein the forecast weather data is based on at least one of the Global Forecasting System (GFS), North American Mesoscale Model (NAM), and Rapid Update Cycle Model (RUC).

9. A system comprising:
a processor; and
a memory communicatively coupled to the processor, the memory storing instructions causing the processor, after execution of the instructions by the processor, to:
receive airport rules, the airport rules comprising a set of heuristically and mathematically derived weather parameters and airport conditions that when exceeded indicate a potential airport delay;
receive airport condition data and forecast weather data from a plurality of sources at regular intervals, the airport condition data comprising airport demand;
parse and normalize the received airport condition data and the forecast weather data;
collect and store the parsed and normalized airport condition data and the forecast weather data; and
apply the airport rules to the airport condition data and the forecast weather data to determine potential airport delays at regular intervals.

10. The system of claim 9, wherein the airport condition data comprises at least one of wind direction and velocity, prevailing visibility, precipitation type and intensity, temperature, dew point, cloud coverage and ceiling height, frontal location, convective activity, icing level, and airport and facility conditions,
wherein the forecast weather data is received from at least one of the Federal Aviation Administration (FAA), National Weather Service (NWS), National Oceanic and Atmospheric Administration (NOAA), private and public weather services, and forecasting entities and meteorologists, and
wherein the forecast weather data is based on at least one of the Global Forecasting System (GFS), North American Mesoscale Model (NAM), and Rapid Update Cycle Model (RUC).

11. A system comprising:
a processor; and
a memory communicatively coupled to the processor, the memory storing instructions causing the processor, after execution of the instructions by the processor, to:
receive a first flight itinerary of a user;
receive condition data and weather forecast data for airports;
estimate a likelihood for a delay of the first flight itinerary based on the condition data and the weather forecast data for airports associated with the first flight itinerary;
identify a second flight itinerary as an alternative for the first flight itinerary;
estimate a likelihood for a delay of the second flight itinerary based on the condition data and the weather forecast data for airports associated with the second flight itinerary; and
notify the user of the estimated likelihood for a delay for the first flight itinerary, the second flight itinerary, and the estimated likelihood for a delay for the second flight itinerary.

12. The system claim 11, wherein the first flight itinerary is received from one of an individual, an airline, and a travel agent.

13. The system claim 11, wherein the estimate of the likelihood for a delay of the first flight itinerary is commenced at least two days prior to a departure of the first flight itinerary.

14. The system claim 11, wherein the estimate of the likelihood for a delay of the first flight itinerary is based on the condition data and the weather forecast data for airports directly and indirectly associated with the second flight itinerary.

15. The system claim 11, wherein the memory stores instructions causing the processor, after execution of the instructions by the processor, to further:
notify the user of airport delays at airports associated with the first flight itinerary.

16. The system claim 11, wherein the memory stores instructions causing the processor, after execution of the instructions by the processor, to further:
update the estimated likelihood for a delay for the first flight itinerary at a regular interval.

17. The system claim 11, wherein the memory stores instructions causing the processor, after execution of the instructions by the processor, to further:
receive user preferences of the user,
wherein the second flight itinerary is identified based on the user preferences.

18. The system claim 11, wherein the memory stores instructions causing the processor, after execution of the instructions by the processor, to further:
verify that the first flight itinerary of the user is a valid flight itinerary.

19. The system claim 11, wherein the memory stores instructions causing the processor, after execution of the instructions by the processor, to further:
receive data from airlines, airports, airport arrival and departure navigational fixes, and aircraft operating characteristics,
wherein the estimated likelihood for a delay of the first flight itinerary is based on the data.

20. The system claim 11, wherein the condition data and the weather forecast data for airports includes at least one of wind direction and velocity, visibility, temperature, dew-point, cloud coverage, ceiling height, precipitation type and intensity, and airport conditions and capabilities.

21. A method comprising:
receiving, via a processing system, user data including a planned flight itinerary;
receiving, via the processing system, condition data and weather forecast data for airports;
evaluating, via the processing system, the planned flight itinerary for potential delays based on the condition data and the weather forecast data at least 24 hours prior to the planned flight itinerary; and
notifying, via the processing system, the user of the potential delays for the planned flight itinerary.

22. The method of claim 21, further comprising:
identifying, via the processing system, an alternative flight itinerary for the planned flight itinerary;
evaluating, via the processing system, the alternative flight itinerary for potential delays based on the condition data and the weather forecast data; and
notifying the user, via the processing system, of the potential delays for the alternative flight itinerary.

23. The method of claim 22, further comprising:
receiving, via the processing system, airline schedules and airline seat availability,
wherein the user data includes user preferences, and
wherein identifying the alternative flight itinerary is based on the airline schedules, the airline seat availability, and the user preferences.

24. The method of claim 21, further comprising:
receiving, via the processing system, airport rules including weather parameters that when exceeded indicate a potential airport delay,
wherein evaluating the planned flight itinerary for potential delays is based on the airport rules.

25. The method for predicting flight itinerary delays, the method comprising:
receiving, via a processing system, user data including planned flight itineraries and user preferences;
receiving, via the processing system, airport condition data, weather forecast data, airline schedules, airline seating availability, and airport rules including weather parameters that when exceeded indicate a potential airport delay;
determining, via the processing system, a likelihood for a delay of each planned flight itinerary based on the airport condition data, the weather forecast data, and the airport rules;
identifying, via the processing system, an alternative flight itinerary if available for each planned flight itinerary where there is a likelihood for a delay, the identification of an alternative flight itinerary based on the user preferences, the airline schedules, and the airline seating availability;
determining, via the processing system, a likelihood for a delay of each alternative flight itinerary based on the airport condition data, the weather forecast data, and the airport rules; and
notifying, via the processing system, each user of the likelihood for a delay for a planned flight itinerary, any alternative flight itinerary, and the likelihood for a delay of any alternative flight itinerary.

26. The method of claim 25, further comprising:
updating, via the processing system, the determination of the likelihood for a delay of each planned flight itinerary at a regular interval.

27. The method of claim 25, further comprising:
identifying, via the processing system, more than one alternative flight itinerary for each planned flight itinerary based on the user preferences, the airline schedules, and the airline seating availability; and
determining, via the processing system, a likelihood for a delay of each of the more than one alternative flight itineraries based on the airport condition data, the weather forecast data, and the airport rules.

28. The method of claim 25, wherein receiving the user preferences comprises receiving user preferences for at least one of arrival and departure time, preferred airline, time window allowable for alternative flight itineraries, duration of total travel, and number of connecting cities.

29. The method of claim 25, further comprising:
notifying, via the processing system, a user when no alternative flight itinerary is available for a planned flight itinerary.

30. The method of claim 25, wherein notifying each user comprises transmitting a message via a communication network to at least one of a personal digital assistant, a wireless phone, a pager, a wireless computer, a desktop computer, a wireless station, a voice response unit, and a user server.
